(19) United States
(12) Patent Application Publication
(10) Pub. No.: US 2021/0079782 A1
(43) Pub. Date: Mar. 18, 2021

(54) AUTONOMOUS LOGGING-WHILE-DRILLING ASSEMBLY

(71) Applicant: Well Resolutions Technology, Houston, TX (US)

(72) Inventor: Borislav J. Tchakarov, Houston, TX (US)

(73) Assignee: Well Resolutions Technology, Houston, TX (US)

(21) Appl. No.: 17/023,849

(22) Filed: Sep. 17, 2020

Related U.S. Application Data
(60) Provisional application No. 62/901,301, filed on Sep. 17, 2019.

(51) Int. Cl. E21B 47/002; E21B 47/04; E21B 49/00; G01V 3/34; G01V 5/04

(52) U.S. Cl. CPC E21B 47/0025; E21B 47/04; G01V 5/04; G01V 3/34; E21B 49/00

(57) ABSTRACT

The present application pertains to a self-powered logging-while-drilling assembly. The assembly has a body comprising a releasable hatch and a battery within said body configured to power the assembly. A memory and/or processor may be employed with a resistivity micro-imager and/or a spectral gamma sensor.

### CROSS-REFERENCE TO RELATED APPLICATIONS

The present application claims priority to U.S. provisional application 62/901,301 filed Sep. 17, 2019 which is incorporated herein by reference.

### BACKGROUND AND SUMMARY

Well logging is the practice of making a detailed record (a “well log”) of the geologic formations penetrated by a borehole. The log may be based on physical measurements made by 15 instruments lowered into the hole. Logging tools may measure the natural gamma ray, electrical, acoustic, stimulated radioactive responses, electromagnetic, nuclear magnetic resonance, pressure and other properties of the rocks and their contained fluids. The data itself is recorded either at surface (e.g., real time mode), or in the hole (e.g., memory mode) to an electronic data format and their either a printed record or electronic presentation called a “well log” is provided. Well logging operations can either be performed during the drilling process, i.e., logging-while-drilling, to provide real-time information about the formations being penetrated by the borehole, or once the well has reached Total Depth and the whole depth of the borehole can be logged.

Wireline logging is performed by lowering a “logging tool”- or a string of one or more instruments—on the end of a wireline into an oil well or borehole and recording petrophysical properties using a variety of sensors. Logging-while-drilling (“LWD”) is a technique of conveying well logging tools into the well borehole downhole as part of the bottom hole assembly (“BHA”). LWD tools work with a measurement-while-drilling (“MWD”) system to transmit partial or complete measurement results to the surface via typically a drilling mud pulser or other techniques, while LWD tools are still in the borehole, which is called real-time data. Complete measurement results can be downloaded from LWD tools after they are pulled out of the hole, which is called “memory data.”

Typically, LWD tools require complex interfacing between the different tools in the BHA, e.g., data links, mechanical, electrical, EE FW and EE SW. The data links in the BHA are often prone to failure and expensive to repair. Highly trained field engineers may be needed to assemble, program, run the tools and interpret the data. What is more, the BHA often employs communication and a power bus providing power and controlling all the tools in the BHA. It is common if one tool fails, to compromise the job.

What is needed then is an improved logging-while-drilling assembly. Advantageously, the present application pertains to a self-powered logging-while-drilling assembly. The assembly has a body comprising a releasable hatch and a battery within said body configured to power the assembly. A memory and/or processor may be employed with a resistivity micro-imager and/or a spectral gamma sensor.

### BRIEF DESCRIPTION OF THE FIGURES

FIG. 1 illustrates an exploded view of an embodiment of a self-powered logging-while-drilling assembly including a resistivity micro-imager.

FIG. 2 illustrates an exploded view of an embodiment of a self-powered logging-while-drilling assembly including a spectral gamma sensor.

### DETAILED DESCRIPTION

A logging-while-drilling (“LWD”) assembly is disclosed. The logging-while-drilling assembly is a self-powered and stand-alone tool. That is, the logging-while-drilling assembly is not dependent upon any external power or communications to function reliably and may be run anywhere in the drilling string, for instance above the mud motor and below the MWD system. Operators may employ the logging-while-drilling assembly when drilling info is not needed in real-time and instead can download the data after the run to decide where to shoot and frack.

The LWD assembly may be synchronized at the surface with a measurement-while-drilling (“MWD”) system in the drilling string for depth correlation for data processing after the job. All measurements are processed and stored in memory and raw data is recorded for quality control. The LWD assembly may be configured to independently acquire a high side tool face angle used for imaging of deviated wells. The LWD assembly is full autonomous and independent from any other tools in the drilling string. The LWD assembly is self-powered by its own dedicated power source of any kind. The LWD assembly is initialized after power-up by synchronizing the tool clock with the LWD assembly. The LWD assembly primarily uses cables and connectors for power up, synchronization and data download or dump after the job. In certain embodiments, the LWD assembly's only interaction with any other tools in the drilling string (if any other tools are present) is to synchronize the tool clock for performing depth correlation of the data after the run. In yet other embodiments, the LWD assembly may be run even without any other tool in the drilling string, and in this case, the depth correlation may be performed using a drill chart.

The LWD assembly may be configured having a smart power safe mode by detecting rotation and vibration, e.g., a “sleep” mode when RPM=0 and there is no vibration. In certain instances, WiFi may be an option when power availability is not an issue, e.g., as is often the case for short tool runs. If the WiFi is not reliable due to interference around the rig floor, the programming and the data download after the run may be performed through a data port using cable and any standard connectors.

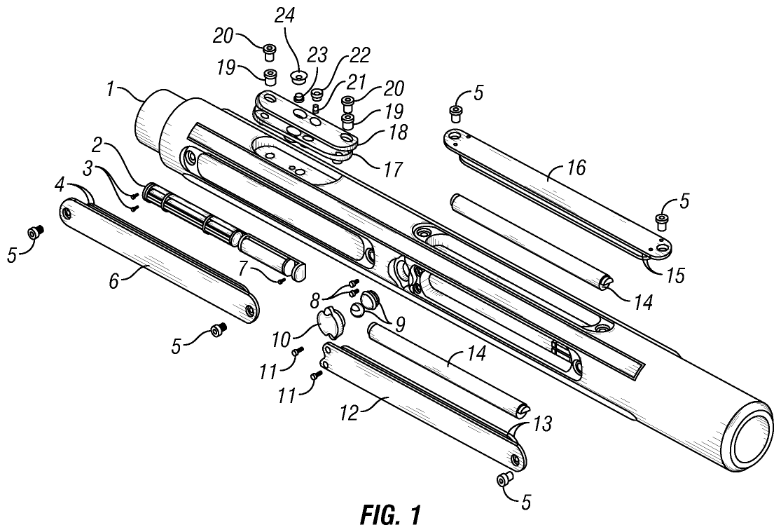

FIG. 1 illustrates an exploded view of an embodiment of a self-powered logging-while-drilling assembly including a resistivity micro-imager. The LWD assembly may run a resistivity micro-imaging pad so the log can identify small and large fractures. The LWD assembly includes a body 1 that contains all components of the LWD assembly. The LWD assembly further includes an electronic chassis 2 that contains equipment such as magnetometers and accelerometers and other equipment for acquiring high side tool face measurements for providing imaging. The electronic chassis 2 may be secured or coupled to the body 1 by fasteners 3 and 7, and sealed by a hatch 6 sealed to the body 1 with seals 4 and secured by fasteners 5. The LWD assembly may be powered by batteries, e.g., lithium batteries, configured as battery sticks 14 disposed in pockets in the tool body 1 and covered using hatches 12 and 16 sealed with seals 13 and 15 and secured to the tool body 1 with fasteners 5 and 11. Additional battery packs may be stacked along the length of the tool to increase battery power. The LWD assembly may be powered on a rig site and programmed using connectors 8 contained for shock and vibration inside plastic bodies 9. The power activation and programming unit is sealed with seals and a small hatch 10. The connector 8 may also be used for data download, e.g., data dump, after the job.

The LWD assembly micro imager includes a guard electrode 18 and imaging electrodes 21 and 23. The guard electrode 18 is isolated from the body 1 with isolator 17 and locked to the body 1 with fasteners 20 thru isolators 19. The imaging electrodes 21 and 23 are isolated from the body 1 thru isolators 22 and 24. The LWD assembly wiring is configured using cross drilling between the pockets, which is well understood by those skilled in the art.

One or more hatches may be sealed using face seals or single/double “O” ring seal configurations understood by those skilled in the art. The number of cavities may vary with the diameter of the LWD assembly, e.g., the number is higher for large diameters and lower for small diameter tools.

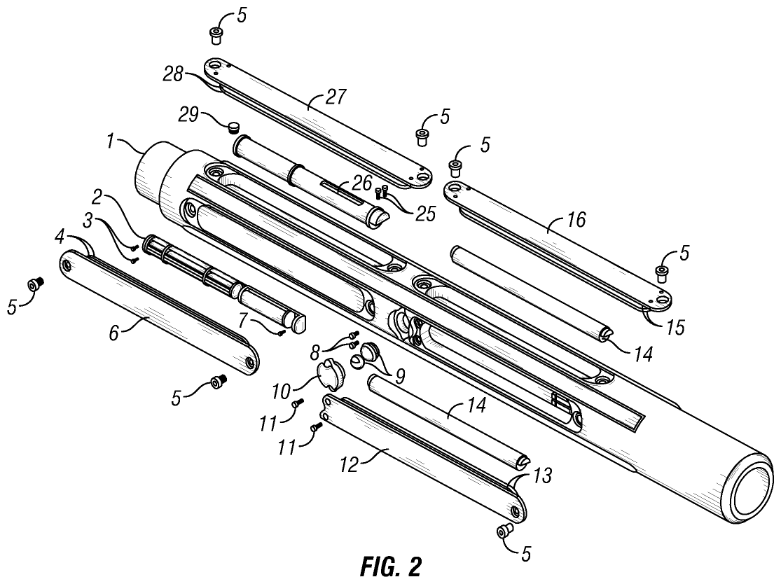

FIG. 2 illustrates an exploded view of an embodiment of a self-powered logging-while drilling assembly including a spectral gamma sensor. In a spectral gamma module, the processed data can identify the intervals with high organic content and perform both measurements in the same tool. The LWD assembly containing the spectral gamma sensor has many similar components to those shown in FIG. 1. The LWD assembly includes a body 1 having a spectral gamma sensor 26 disposed within a cavity in the body 1 and secured using fasteners 25. The spectral gamma sensor 26 is isolated from the body 1 and the rest of the LWD tool with a pressure bulkhead 29 in case of any leaks. The spectral gamma sensor 26 may be locked and sealed within the cavity of the body 1 by a hatch 27 with seals 28 and fasteners 5.

Advantageously, operators may save significant costs by running the LWD assembly on its own and obtaining valuable well data for future well design stages while paying only a fraction of the typical cost. The LWD assembly processes the measurement data and stores both raw and processed data. The raw data and readings of the magnetic and gravitational fields may be used for validating the measurements; the processed data may then be used for a fast initial assessment of the well.

In additional embodiments one may replace spectral gamma with another suitable type of measurement or combination of measurements. For example, a resistivity measurement may be useful. The type of resistivity measurement employed may depend on the well, its characteristics, and the desired results. However, one type of useful resistivity may be azimuthal resistivity and more particularly one in which it is used as a standalone measurement. Such measurements and tools therefore are described in, for example, the following U.S. Pat. Nos. which patents are incorporated herein by reference:
U.S. Pat. No. 10,365,391 Apparatus and methods for making azimuthal resistivity measurements with off-set directional antennas
U.S. Pat. No. 10,337,322 Modular resistivity sensor for downhole measurement while drilling
U.S. Pat. No. 10,253,614 Apparatus and methods for making azimuthal resistivity measurements
U.S. Pat. No. 10,072,490 Boundary tracking control module for rotary steerable systems
U.S. Pat. No. 9,952,347 Apparatus and methods for making azimuthal resistivity measurements
U.S. Pat. No. 9,851,465 Apparatus and methods for communicating downhole data
U.S. Pat. No. 9,767,153 Apparatus and methods for making azimuthal resistivity measurements
U.S. Pat. No. 9,645,276 Apparatus and methods for making azimuthal resistivity measurements
U.S. Pat. No. 9,638,819 Modular resistivity sensor for downhole measurement while drilling
U.S. Pat. No. 9,575,201 Apparatus and method for downhole resistivity measurements
U.S. Pat. No. 9,359,889 System and methods for selective shorting of an electrical insulator section
U.S. Pat. No. 9,268,053 Apparatus and methods for making azimuthal resistivity measurements

What is claimed is:

1. A self-powered logging-while-drilling assembly comprising:
a body comprising a releasable hatch;
an electronic chassis within said body;
a battery within said body configured to power the assembly; and
a resistivity micro-imager; and
a memory for recording data.

2. The self-powered logging-while-drilling assembly of claim 1 wherein the resistivity micro-imager is configured to identify fracture size wherein said resistivity microimager comprises a guard electrode and two or more imaging electrodes.

3. The self-powered logging-while-drilling assembly of claim 1 further comprising a magnetometer within the electronic chassis.

4. The self-powered logging-while-drilling assembly of claim 1 further comprising an accelerometer within the electronic chassis.

5. The self-powered logging-while-drilling assembly of claim 1 wherein the assembly is configured to acquire a high side tool face angle for imaging a deviated well.

6. The self-powered logging-while-drilling assembly of claim 1 wherein the battery is a lithium battery.

7. The self-powered logging-while-drilling assembly of claim 1 wherein the self-powered logging-while-drilling assembly is configured to synchronize with a measurement-while-drilling system for depth correlation.

8. The self-powered logging-while-drilling assembly of claim 1 wherein the self-powered logging-while-drilling assembly is configured to acquire a high side tool face angle for imaging of a deviated well.

9. The self-powered logging-while-drilling assembly of claim 1 wherein the self-powered logging-while-drilling assembly is configured to synchronize with a tool clock.

10. The self-powered logging-while-drilling assembly of claim 1 further comprising a data port to download data from the memory.

11. The self-powered logging-while-drilling assembly of claim 1 further comprising a processor.

12. A self-powered logging-while-drilling assembly comprising:
a body comprising a releasable hatch;
a battery within said body configured to power the assembly;
a resistivity micro-imager;
a memory for recording data; and
a spectral gamma sensor.

13. The self-powered logging-while-drilling assembly of claim 12 wherein the spectral gamma sensor is configured to identify regions of high organic content.

14. The self-powered logging-while-drilling assembly of claim 12 wherein the spectral gamma sensor is disposed within a cavity in the body.

15. The self-powered logging-while-drilling assembly of claim 12 further comprising a pressure bulkhead to isolate the spectral gamma sensor from the body.

15. The self-powered logging-while-drilling assembly of claim 12 further comprising an apparatus for azimuthal resistivity measurements.

16. The self-powered logging-while-drilling assembly of claim 12 further comprising a magnetometer.

17. The self-powered logging-while-drilling assembly of claim 12 further comprising an accelerometer.

18. The self-powered logging-while-drilling assembly of claim 12 wherein the assembly is configured to acquire a high side tool face angle for imaging a deviated well.

19. The self-powered logging-while-drilling assembly of claim 12 wherein the battery is a lithium battery.

20. The self-powered logging-while-drilling assembly of claim 12 further comprising a processor.
